(19) United States
(12) Patent Application Publication
(10) Pub. No.: US 2021/0159972 A1
(43) Pub. Date: May 27, 2021

(54) MONITORING DEVICE AND MONITORING METHOD

(71) Applicant: NEC Corporation, Minato-ku, Tokyo (JP)

(72) Inventor: Yuhei MATSUMOTO, Tokyo (JP)

(73) Assignee: NEC Corporation, Minato-ku, Tokyo (JP)

(21) Appl. No.: 17/259,759

(22) PCT Filed: Jul. 23, 2019
(86) PCT No.: PCT/JP2019/028769

§ 371 Date: Jan. 12, 2021

(30) Foreign Application Priority Data
Jul. 27, 2018 (JP) 2018-141187

(51) Int. Cl. H04B 10/077

(52) U.S. Cl. CPC H04B 10/077

(57) ABSTRACT

To provide a monitoring device capable of specifying an abnormality occurrence point without requiring much time, the monitoring device is provided with a reception means 1 for acquiring information about variation of the optical power level of a control signal transmitted to a transmission path and a monitoring means 2, when the variation of the optical power level of the control signal does not satisfy a prescribed condition, for monitoring the transmission path on the basis of back-scattered light of an optical pulse outputted to the transmission path.

### TECHNICAL FIELD

The present invention relates to an optical communication technology, and in particular, relates to a technique for monitoring presence/absence of an anomaly in a transmission path.

### BACKGROUND ART

As an optical communication network has been widely used, it becomes important to ensure stability and security of communication. In the optical communication network, a communication failure due to damage to an optical fiber and deterioration in security due to an act of eavesdropping called tapping may occur. The act of eavesdropping by tapping is done, for example, by removing a coating of an optical fiber and connecting an eavesdropping device to the optical fiber.

In order to ensure stability and security of communication, it is important to identify, when a possibility of damage or eavesdropping on an optical fiber rises, a location where the damage or the eavesdropping occurs, and respond quickly. Therefore, when a possibility of damage or eavesdropping on an optical fiber rises, it is desirable that identification of a location of occurrence can be performed quickly. On the basis of such a background, in an optical communication network, a technique for detecting a possibility of damage or eavesdropping on an optical fiber and a technique for identifying a location of occurrence have been developed. As such a technique for performing detection and the like of occurrence of damage or eavesdropping on an optical fiber, for example, a technique as in PTL 1 is disclosed.

PTL 1 relates to a monitoring device for an optical communication network. The monitoring device in PTL 1 includes an optical time domain reflectometer (OTDR) being connected to a plurality of transmission paths via an optical switch. The monitoring device in PTL 1 performs OTDR measurement for each of the transmission paths by switching the optical switch, and checks presence/absence of an anomaly in each of the transmission paths.

### CITATION LIST

### Patent Literature

[PTL 1] Japanese Unexamined Patent Application Publication (Translation of PCT Application) No. 2017-521981

### SUMMARY OF INVENTION

### Technical Problem

However, the technique in PTL 1 is not sufficient in a point as follows. The monitoring device in PTL 1 transmits a management frame for each transmission path by switching a switch, and performs OTDR measurement for a transmission path in which an anomaly is present. Therefore, in order to check presence/absence of an anomaly in each transmission path, it is necessary to transmit, to all the transmission paths, a management frame with the switch switched, and performs OTDR measurement for a transmission path in which an anomaly is detected. However, the monitoring device in PTL 1 may need much time to detect a transmission path in which an anomaly occurs. Further, the monitoring device in PTL 1 may be less accurate in identifying a location where an anomaly occurs on a long-distance transmission path such as transmission paths connected via a plurality of repeaters. Therefore, PTL 1 is not sufficient as a technique for accurately identifying a location where a failure occurs in an optical fiber without needing much time.

In order to solve the above-described problem, an object of the present invention is to provide a monitoring device capable of accurately identifying a location where a failure occurs, without needing much time.

### Solution to Problem

In order to solve the above-described problem, a monitoring device according to the present invention includes a reception means and a monitoring means. The reception means acquires information of level variation in optical power of a control signal transmitted to a transmission path. When the level variation in the optical power of the control signal does not satisfy a predetermined condition, the monitoring means monitors the transmission path, based on backscattered light of an optical pulse being output to the transmission path.

A monitoring method according to the present invention includes acquiring information of level variation in optical power of a control signal transmitted to a transmission path, and monitoring, when the level variation in the optical power of the control signal does not satisfy a predetermined condition, the transmission path, based on backscattered light of an optical pulse being output to the transmission path.

### Advantageous Effects of Invention

According to the present invention, a location where a failure occurs can be accurately identified without needing much time.

### BRIEF DESCRIPTION OF DRAWINGS

FIG. 1 is a diagram illustrating an outline of a configuration of a first example embodiment of the present invention.

FIG. 2 is a diagram illustrating an outline of a configuration of a second example embodiment of the present invention.

FIG. 3 is a diagram illustrating a configuration of terminal equipment according to the second example embodiment of the present invention.

FIG. 4 is a diagram illustrating a configuration of a monitoring device according to the second example embodiment of the present invention.

FIG. 5 is a diagram illustrating an example of the configuration of the monitoring device according to the second example embodiment of the present invention.

FIG. 6 is a diagram illustrating an example of scattered light intensity measured in the second example embodiment of the present invention.

FIG. 7 is a diagram illustrating an operational flow of the second example embodiment of the present invention.

FIG. 8 is a diagram illustrating the operational flow of the second example embodiment of the present invention.

FIG. 9 is a diagram schematically illustrating an example of a location where an anomaly occurs in the second example embodiment of the present invention.

FIG. 10 is a diagram schematically illustrating an operation when an anomaly occurs in the second example embodiment of the present invention.

FIG. 11 is a diagram schematically illustrating an operation when an anomaly occurs in the second example embodiment of the present invention.

FIG. 12 is a diagram schematically illustrating an operation when an anomaly occurs in the second example embodiment of the present invention.

### EXAMPLE EMBODIMENT

### First Example Embodiment

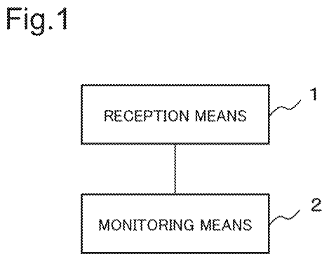

A first example embodiment of the present invention is described in detail with reference to a drawing. FIG. 1 is a diagram illustrating an outline of a configuration of a monitoring device according to the present example embodiment. The monitoring device according to the present example embodiment includes a reception means 1 and a monitoring means 2. The reception means 1 acquires information of level variation in optical power of a control signal transmitted to a transmission path. When the level variation in the optical power of the control signal does not satisfy a predetermined condition, the monitoring means 2 monitors the transmission path, based on backscattered light of an optical pulse being output to the transmission path.

When the level variation in the optical power of the control signal output to the transmission path does not satisfy the predetermined condition, the monitoring device according to the present example embodiment monitors the transmission path, based on backscattered light of the optical pulse. The monitoring device according to the present example embodiment monitors the transmission path when the level variation in the optical power of the control signal in the transmission path in which the monitoring device is installed does not satisfy the predetermined condition, and thereby is capable of determining presence/absence of an anomaly and identifying a location where the anomaly occurs, without needing much time. Consequently, by using the monitoring device according to the present example embodiment, a location where a failure occurs can be accurately identified without needing much time.

### Second Example Embodiment

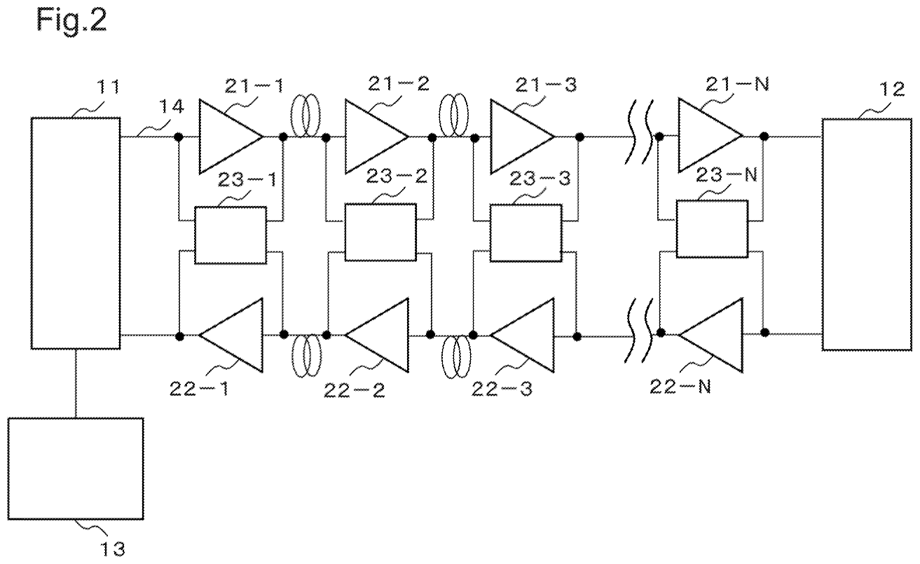

A second example embodiment of the present invention is described with reference to drawings. FIG. 2 is a diagram illustrating an outline of a configuration of an optical communication system according to the present example embodiment. The optical communication system according to the present example embodiment is an optical communication network for transmitting/receiving a wavelength multiplexed signal between pieces of terminal equipment via a transmission path.

The optical communication system according to the present example embodiment includes first terminal equipment 11, second terminal equipment 12, a communication control device 13, and a transmission path 14. The first terminal equipment 11 and the second terminal equipment 12 are connected via the transmission path 14.

The transmission path 14 further includes optical amplifiers 21 and 22, and a monitoring device 23. N pieces (N is an integer) of optical amplifiers 21 being optical amplifiers 21-1 to 21-N are included in the transmission path 14. Further, N pieces of optical amplifiers 22 being optical amplifiers 22-1 to 22-N are included associated with the optical amplifier 21. N pieces of monitoring devices 23 being monitoring devices 23-1 to 23-N are included associated with the optical amplifier 21 and the optical amplifier 22.

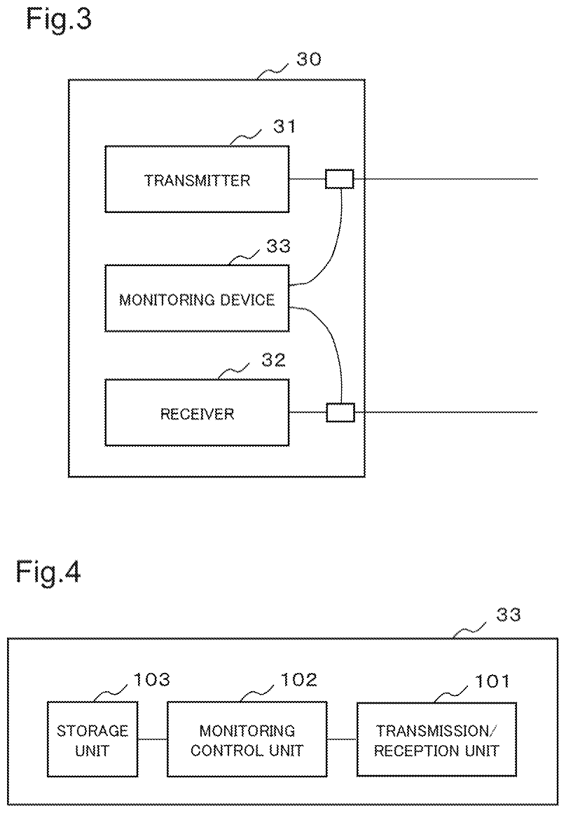

A configuration of the first terminal equipment 11 and the second terminal equipment 12 is described. FIG. 3 is a diagram illustrating the configuration of the first terminal equipment 11 and the second terminal equipment 12, as terminal equipment 30. As illustrated in FIG. 3, the terminal equipment 30 includes a transmitter 31, a receiver 32, and a monitoring device 33.

The transmitter 31 generates, based on a client signal input to the terminal equipment 30, an optical signal for each channel to be transmitted in the transmission path 14, and outputs the generated optical signal as a wavelength multiplexed signal. The transmitter 31 includes an optical transmission module for generating, based on an input signal, an optical signal having a wavelength relevant to each channel, and a multiplexing element for multiplexing optical signals having each wavelength.

The receiver 32 demultiplexes a wavelength multiplexed signal input from a transmission path, decodes an optical signal of each channel, and outputs the decoded optical signal as a client signal. The receiver 32 includes a demultiplexing element for demultiplexing an input wavelength multiplexed signal, and an optical reception module for performing reception processing of an optical signal having each wavelength.

A configuration of the monitoring device 33 is described. FIG. 4 is a diagram illustrating the configuration of the monitoring device 33 according to the present example embodiment. The monitoring device 33 includes a transmission/reception unit 101, a monitoring control unit 102, and a storage unit 103.

The transmission/reception unit 101 includes a light source for outputting optical supervisory channel (OSC) light and an optical pulse for optical time domain reflectometer (OTDR) measurement, and a photodetector for detecting OSC light and an optical pulse for the OTDR measurement. Further, the transmission/reception unit 101 has a function of measuring optical power of light received by the photodetector. The transmission/reception unit 101 outputs, to the monitoring control unit 102, a measurement result of the optical power.

OSC light and an optical pulse for the OTDR measurement are multiplexed with a wavelength multiplexed signal output from the transmitter 31, and are transmitted to the transmission path 14. A multiplexing element is configured by using, for example, arrayed waveguide gratings (AWG). The multiplexing element may be configured by using another optical element such as a wavelength selective switch.

The monitoring control unit 102 controls an operation of the transmission/reception unit 101 of transmitting, to a transmission path, OSC light and an optical pulse for the OTDR measurement.

Further, the transmission/reception unit 101 receives OSC light transmitted from another one of the monitoring devices 23 or another piece of terminal equipment. The transmission/reception unit 101 transmits, to the monitoring control unit 102, the received OSC light.

The monitoring control unit 102 has a function of determining, based on a measurement result of OSC light and optical power for the OTDR measurement, presence/absence of an anomaly. The monitoring control unit 102 compares a result of the OTDR measurement with reference data preliminarily stored as a database, and determines presence/absence of an anomaly. The monitoring control unit 102 estimates, based on a result of the OTDR measurement, a location where an anomaly occurs. The monitoring control unit 102 stores, in the storage unit 103, the result of the OTDR measurement in a normal state.

When detecting that variation in optical power of OSC light is equal to or more than a reference, the monitoring control unit 102 transmits, to an upstream monitoring device 23, information indicating that the variation occurs in the optical power of the OSC light. In the following description, upstream refers to a transmission source side of a wavelength multiplexed signal transmitted in the transmission path 14, and downstream refers to a transmission destination side of the wavelength multiplexed signal transmitted in the transmission path 14.

When receiving, from a downstream monitoring device 23, a notification indicating that variation occurs in OSC light, the monitoring control unit 102 controls the transmission/reception unit 101 in such a way as to perform output of an optical pulse for the OTDR measurement and measurement of backscattered light.

The monitoring control unit 102 identifies, based on a result of the OTDR measurement, a distance to a location where an anomaly occurs. After calculating the distance to the location where the anomaly occurs, the monitoring control unit 102 transmits, to the communication control device 13, information indicating that the anomaly occurs, information of the location where the anomaly occurs, information of an excess loss, and the like.

The storage unit 103 has a function of storing a result of the OTDR measurement. The storage unit 103 stores measurement data of the OTDR measurement in a state in which OSC light is normal, in association with a date and time of the OTDR measurement. The measurement data are recorded as data of optical power of backscattered light, with respect to time.

The communication control device 13 performs monitoring of the optical communication system, control of the terminal equipment, and the like. When receiving, from the monitoring device, information indicating an anomaly in the transmission path and information of a location of occurrence, the communication control device 13 notifies, by display or the like, a worker and the like of occurrence of the anomaly and the location of occurrence.

The optical amplifier 21 amplifies optical power of signal light of a wavelength multiplexed signal transmitted from the first terminal equipment 11 to the second terminal equipment 12. Each of the optical amplifiers 21 according to the present example embodiment includes an erbium doped fiber optical amplifier (EDFA) and a pumping light source.

The optical amplifier 21 includes, in a former stage of the EDFA, i.e., in an input side, a demultiplexing element for demultiplexing a wavelength multiplexed signal, and OSC light and an optical pulse of OTDR. The demultiplexing element is configured by using, for example, AWG, and demultiplexes OSC light and light having a wavelength allocated for the OTDR measurement, and signal light of a wavelength multiplexed signal. The optical amplifier 21 transmits, to the transmission/reception unit 101, the OSC light and light for the OTDR measurement.

Further, the optical amplifier 21 includes, in a later stage, i.e., in an output side, a multiplexing element for multiplexing OSC light and an optical pulse for the OTDR measurement to a wavelength multiplexed signal having optical power amplified by the EDFA. The multiplexing element is configured by using AWG. Backscattered light of an optical pulse for the OTDR measurement is made incident on the multiplexing element from the transmission path 14, and transmitted to the monitoring device 23.

The optical amplifier 22 amplifies optical power of signal light of a wavelength multiplexed signal transmitted from the second terminal equipment 12 to the first terminal equipment 11. Each of the optical amplifiers 21 according to the present example embodiment includes an erbium doped fiber optical amplifier (EDFA) and a pumping light source.

The optical amplifier 22 includes, in a former stage of an EDFA, i.e., in an input side, a demultiplexing element for demultiplexing a wavelength multiplexed signal, and OSC light and an optical pulse of OTDR. The demultiplexing element is configured by using, for example, AWG, and demultiplexes OSC light and light having a wavelength allocated for the OTDR measurement, and signal light of a wavelength multiplexed signal. The optical amplifier 22 transmits, to the transmission/reception unit 101, the OSC light and the optical pulse for the OTDR measurement.

Further, the optical amplifier 22 includes, in a later stage, i.e., in an output side, a multiplexing element for multiplexing OSC light and an optical pulse for the OTDR measurement to a wavelength multiplexed signal having optical power amplified by the EDFA. The multiplexing element is configured by using AWG.

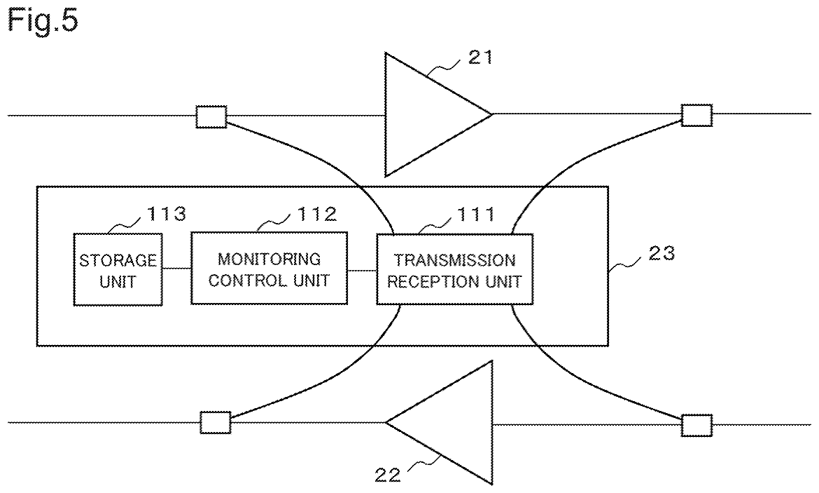

A configuration of the monitoring device 23 is described. FIG. 5 is a diagram illustrating the configuration of the monitoring device 23 according to the present example embodiment. The monitoring device 23 includes a transmission/reception unit 111, a monitoring control unit 112, and a storage unit 113.

The transmission/reception unit 111 includes a light source for outputting OSC light and an optical pulse for the OTDR measurement, and a photodetector for detecting OSC light and backscattered light of an optical pulse for the OTDR measurement. Backscattered light of an optical pulse for the OTDR measurement input from a transmission path via AWG is transmitted, by a directional coupler, only to the photodetector. Further, the transmission/reception unit 111 has a function of measuring optical power of light received by the photodetector.

The transmission/reception unit 111 outputs, to the monitoring control unit 112, a measurement result of optical power. Among the functions of the transmission/reception unit 111 according to the present example embodiment, a function of receiving OSC signal light transmitted from another device corresponds to the reception means 1 according to the first example embodiment.

The monitoring control unit 112 controls an operation of transmission/reception unit 111 of transmitting, to a transmission path, OSC light and an optical pulse for the OTDR measurement.

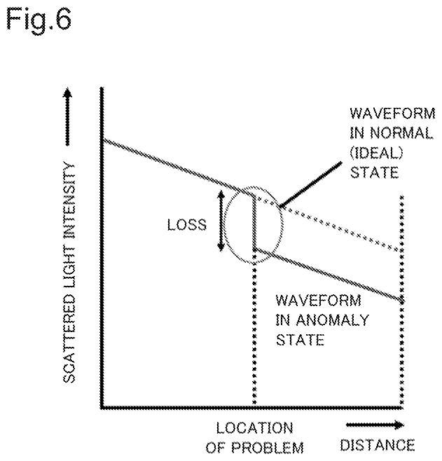

The monitoring control unit 112 has a function of determining, based on a measurement result of OSC light and optical power for the OTDR measurement, presence/absence of an anomaly. FIG. 6 is a diagram schematically illustrating a measurement result of backscattered light. FIG. 6 illustrates a measurement result of optical power of backscattered light, with respect to elapsed time since an optical pulse is output.

A measurement result of back scattered light reflects a distance from an output location of an optical pulse in proportion to time, and therefore a horizontal axis in FIG. 6 corresponds to distance. When bending, tapping, or the like occurs in an optical fiber, a large loss occurs in a location where the bending, tapping, or the like occurs, and therefore intensity of scattered light changes discontinuously in the location where an anomaly occurs as illustrated in FIG. 6. For this reason, a distance to a location where an anomaly occurs can be calculated by detecting a location of discontinuous change as illustrated in FIG. 6 and converting, based on a propagation speed of light or the like, a time elapsed since an optical pulse is output into a distance.

The monitoring control unit 112 stores, in the storage unit 113, the result of the OTDR measurement in a normal state. The monitoring control unit 112 calculates, for example, with respect to a plurality of pieces of OTDR measurement data in a normal state, an average of optical power of backscattered light for each elapsed time since an optical pulse is output, and when a difference between the average value and a measured value is equal to or more than a preliminarily set value, determines that an anomaly occurs. The monitoring control unit 112 may determine that an anomaly occurs, when a time in which the difference between the average value and the measured value is equal to or more than the preliminarily set value lasts equal to or longer than a preliminarily set time. By such a configuration, an influence of temporary fluctuation is reduced, and thereby occurrence of an anomaly can be accurately detected.

When detecting that variation in optical power of OSC light is equal to or more than a reference, the monitoring control unit 112 transmits, to an upstream monitoring device 23, information indicating that an anomaly occurs, via an OSC.

When receiving, from a downstream monitoring device 23, a notification indicating that an anomaly occurs in OSC light, the monitoring control unit 112 controls the transmission/reception unit 111 in such a way as to output an optical pulse and perform the OTDR measurement.

The monitoring control unit 112 identifies, based on measurement data of OTDR, a distance to a location where an anomaly occurs. The monitoring control unit 112 transmits, to the communication control device 13, information indicating that the anomaly occurs, information of the location where the anomaly occurs, information of an excess loss, and the like, via the first terminal equipment 11 or the second terminal equipment 12. Among the functions of the monitoring control unit 112 according to the present example embodiment, a function of controlling, when level variation in optical power does not satisfy a predetermined condition, output of an optical pulse and measurement of backscattered light corresponds to the monitoring means 2 according to the first example embodiment.

The storage unit 113 has a function of storing a result of the OTDR measurement. The storage unit 113 stores, as a database, measurement data of OTDR measurement when variation in optical power of OSC light is within a normal range, in association with a date and time of the OTDR measurement. The measurement data are recorded as data of optical power of backscattered light, with respect to elapsed time since an optical pulse is output. Environmental data such as temperature data may further be associated with the measurement data.

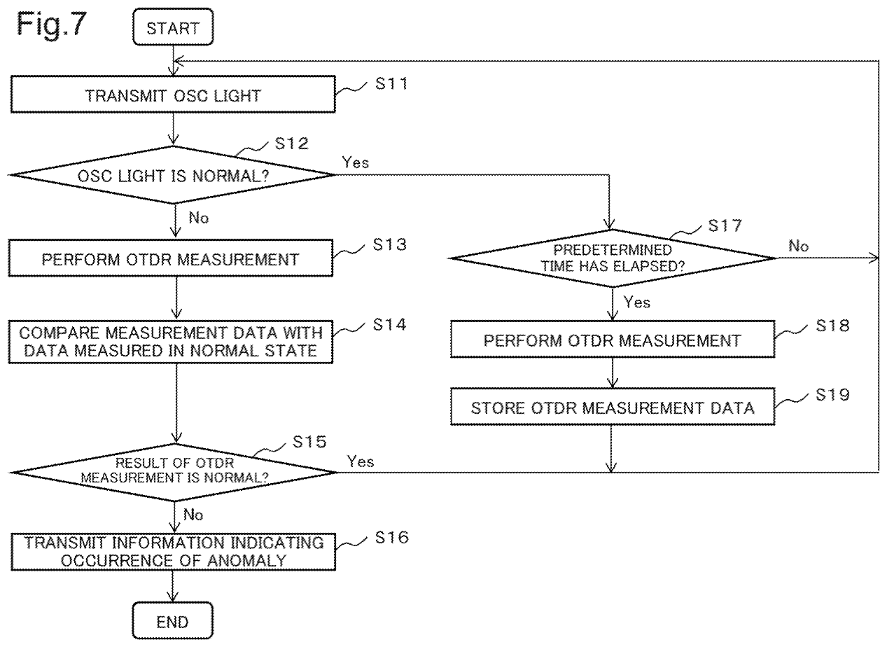

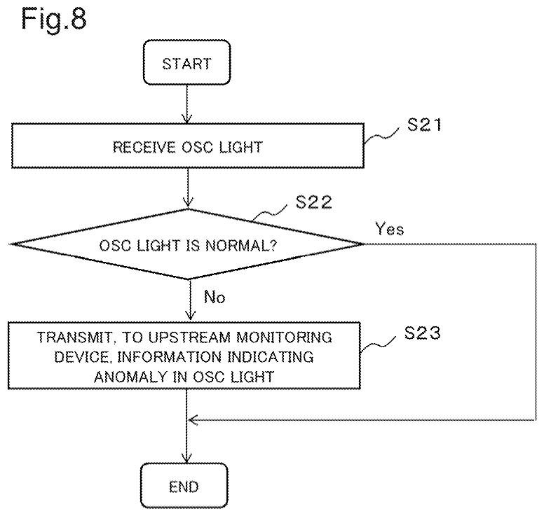

An operation of the optical communication system according to the present example embodiment is described. FIGS. 7 and 8 are diagrams illustrating an operation flow of the monitoring device when the monitoring device monitors presence/absence of an anomaly in the optical communication system according to an example embodiment. FIG. 7 illustrates an operation flow of a device at an upstream side, among monitoring devices adjacent to each other. Further, FIG. 8 illustrates an operation flow of a device at a downstream side, among monitoring devices adjacent to each other.

In the following description, an operation in which, in a section between the monitoring devices 23-2 and 23-3, a side of the monitoring device 23-2 is the upstream side is described as an example, and a similar operation is performed between the other monitoring devices 23, and between the monitoring device 33, of the first terminal equipment 11 and the second terminal equipment 12, and an adjacent one of the monitoring device 23.

In a normal state, the monitoring control unit 112 of the monitoring device 23-2 at the upstream side transmits, via the transmission/reception unit 111, OSC light to the transmission path 14 (Step S11). The OSC light is generated based on a control signal or a dummy signal.

The monitoring control unit 112 of the monitoring device 23-3 at the downstream side receives the OSC light at the transmission/reception unit 111 (Step S21). The monitoring control unit 112 monitors variation in OSC light power received at the transmission/reception unit 111, and determines whether a variation amount is within a predetermined reference. When the variation in the optical power of the OSC light is within the predetermined reference (Yes in Step S22), the monitoring control unit 112 continues monitoring optical power of OSC light measured at the transmission/reception unit 111.

The monitoring control unit 112 of the monitoring device 23-2 at the upstream side checks whether information transmitted from the downstream monitoring device 23-3 indicating an anomaly in the OSC light is received. When the information of anomaly is not received, i.e., the OSC light is normal (Yes in Step S12), the monitoring control unit 112 checks an elapsed time since a last time the OTDR measurement was performed.

When a predetermined time has not elapsed since the OTDR measurement was performed (No in Step S17), the monitoring control unit 112 continues controlling transmission of OSC light in Step S11. The predetermined time used as a reference in determining whether the OTDR measurement is required is preliminarily set.

When the predetermined time has elapsed since the OTDR measurement is performed (Yes in Step S17), the monitoring control unit 112 controls the transmission/reception unit 111 in such a way as to perform the OTDR measurement (Step S18).

When the monitoring control unit 112 starts the OTDR measurement, the transmission/reception unit 111 outputs an optical pulse, and measures optical power of backscattered light for each elapsed time. The transmission/reception unit 111 transmits, to the monitoring control unit 112, measurement data of the OTDR measurement.

When the OTDR measurement data are received, the monitoring control unit 112 stores the measurement data in a storage unit, in association with information of a date and time of the measurement (Step S19). After storing the measurement data, the monitoring control unit 112 continues controlling transmission of OSC light in Step S11.

When the monitoring device 23-3 at the downstream side receives OSC light and a variation amount in optical power of the OSC light is equal to or more than a predetermined reference (No in Step S22), the monitoring control unit 112 transmits, to a transmission source of the OSC light, information indicating that an anomaly occurs in the OSC light, via the transmission/reception unit 111 (Step S23).

When detecting, from a received signal, the information indicating an anomaly occurs in the OSC light (No in Step S12), the monitoring control unit 112 of the monitoring device 23-2 at the upstream side controls the transmission/reception unit 111 in such a way as to perform the OTDR measurement (Step S13).

When the monitoring control unit 112 starts the OTDR measurement, the transmission/reception unit 111 outputs an optical pulse, and measures optical power of backscattered light for each elapsed time. The transmission/reception unit 111 transmits, to the monitoring control unit 112, measurement data of the OTDR measurement.

When receiving the measurement data of the OTDR measurement, the monitoring control unit 112 compares the received measurement data with measurement data in a normal state stored in the storage unit 113 (Step 14).

When the measurement data and the data in a normal state are compared and a difference between the measurement data and the measurement data in a normal state is within a reference (Yes in Step S15), the monitoring control unit 112 determines that an optical fiber is in a normal state in which bending or tapping does not occur. When determining that the optical fiber is in the normal state, the monitoring control unit 112 continues controlling transmission of OSC light in Step S11. Further, when variation is present in OSC light and it is determined by the OTDR measurement that an anomaly is absent, the monitoring control unit 112 may determine that there is a sign of anomaly and may transmit, to the communication control device 13, information indicating that variation is present in the OSC light and an anomaly is absent in the OTDR measurement.

When the measurement data and the data in a normal state are compared and a difference between the measurement data and the data in a normal state is equal to or more than the reference (No in Step S15), the monitoring control unit 112 determines that an anomaly occurs in an optical fiber and the like. When determining that an anomaly occurs in the optical fiber and the like, a monitoring control unit transmits, to 112 and the communication control device 13, information indicating that an anomaly occurs (Step S16).

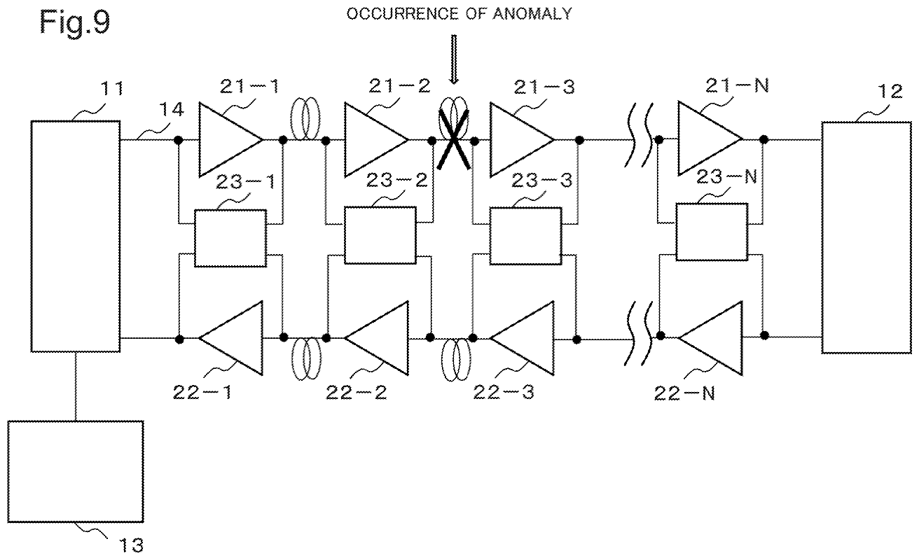

FIGS. 9 to 12 are diagrams schematically illustrating an example of an operation when, in the optical communication system according to the present example embodiment, an anomaly occurs between the optical amplifier 21-2 and the optical amplifier 21-3.

When damage, tapping, or the like on an optical fiber of the transmission path 14 occurs between the optical amplifier 21-2 and the optical amplifier 21-3 as illustrated in FIG. 9, the monitoring device 23-3 detects variation in optical power of OSC light that the monitoring device 23-3 receives.

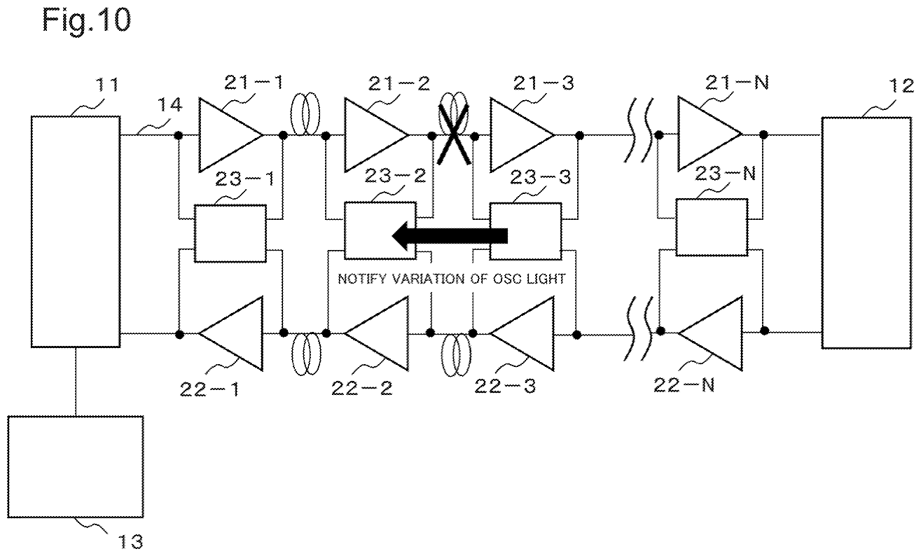

When variation in optical power of OSC light exceeds a preliminarily set reference and no longer satisfies a predetermined condition, the monitoring device 23-3 transmits, to the monitoring device 23-2, information indicating that an anomaly occurs in the OSC light. FIG. 10 is a diagram schematically illustrating an operation that the monitoring device 23-3 notifies the monitoring device 23-2 of information indicating that an anomaly occurs in OSC light. The monitoring device 23-3 transmits the information indicating that an anomaly occurs in the OSC light by using an OSC via an optical fiber in an opposite direction of a direction in which the anomaly is detected.

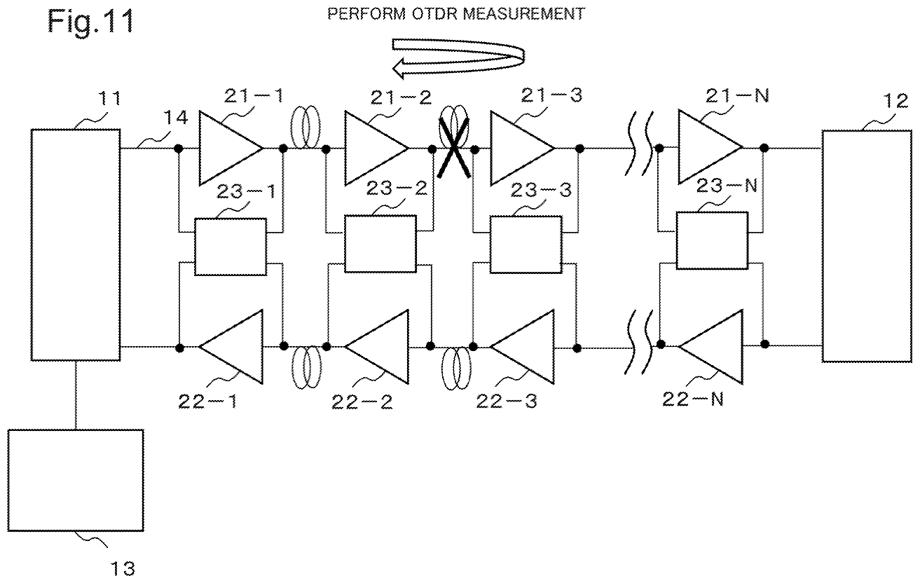

When receiving the information indicating that the anomaly occurs in the OSC light, the monitoring device 23-2 performs the OTDR measurement in a transmission path between the monitoring device 23-2 and the monitoring device 23-3. FIG. 11 is a diagram schematically illustrating an operation of OTDR measurement that the monitoring device 23-2 performs in the transmission path between the monitoring device 23-2 and the monitoring device 23-3.

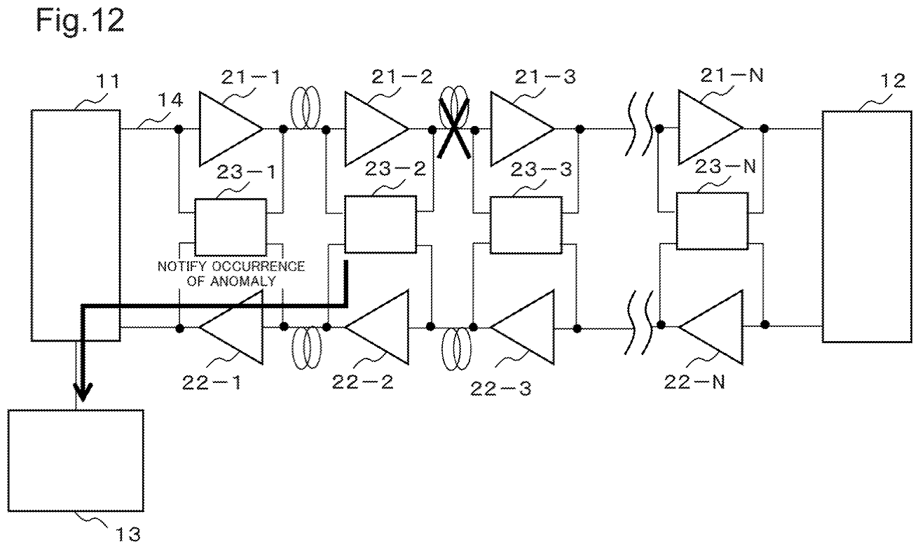

When it is determined, as a result of the OTDR measurement, that an anomaly occurs in a transmission path, the monitoring device 23-2 identifies a location where the anomaly occurs. When the location of anomaly is identified, the monitoring device 23-2 transmits, to the communication control device 13, information indicating that the anomaly occurs in the optical fiber and information of the location of anomaly, via the first terminal equipment 11. FIG. 12 is a diagram schematically illustrating an operation in which the monitoring device 23-2 transmits, to the communication control device 13, the information that the anomaly occurs in the optical fiber, via the first terminal equipment 11.

When receiving the information indicating that the anomaly occurs in the optical fiber, the communication control device 13 notifies, by screen display or the like, a worker and the like of the information indicating that the anomaly occurs and the information of the location where the anomaly occurs. In this way, by monitoring optical power of OSC light, performing OTDR measurement in a section in which variation equal to or more than a reference occurs, and thereby determining presence/absence of an anomaly and identifying a location of occurrence, the monitoring device 23-2 can reduced time required for identifying a location of an anomaly.

The optical communication system according to the present example embodiment monitors, at a monitoring device included in a transmission path, optical power of OSC signal light transmitted from upstream, and when variation in the optical power exceeds a predetermined condition, OTDR measurement is performed by an upstream monitoring device. The optical communication system according to the present example embodiment continuously monitors, in an OSC, transmitted/received signal light, and when an anomaly occurs, performs the OTDR measurement in a section where the anomaly occurs, and is thereby capable of detecting an anomaly and identifying a location of occurrence quickly. Further, by monitoring OSC signal light as a monitoring target, a device configuration required for detecting an anomaly can be simplified.

In the second example embodiment, when receiving, from a downstream monitoring device, a notification indicating that variation level of optical power of OSC light exceeds a reference, each monitoring device outputs, to a downstream transmission path, an optical pulse for OTDR measurement. Instead of such a configuration, a monitoring device that has detected that a variation level reference of optical power of OSC light is exceeded may output, to the upstream side, an optical pulse for the OTDR measurement and perform the OTDR measurement. By a configuration in which the OTDR measurement is performed at the upstream side, a device that detects level variation in optical power of OSC light and a device that performs the OTDR measurement become the same monitoring device, and therefore presence/absence of an anomaly and a location of the anomaly can be autonomously identified by a single monitoring device. Therefore, when a failure in transmission of signal light occurs in one section, occurrence of an anomaly and a location of occurrence can be notified via terminal equipment at an opposite side.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-141187, filed on Jul. 27, 2018, the disclosure of which is incorporated herein in its entirety by reference.

### REFERENCE SIGNS LIST

1 Reception means
2 Monitoring means
11 First terminal equipment
12 Second terminal equipment
13 Communication control device
14 Transmission path
21 Optical amplifier
22 Optical amplifier
23 Monitoring device
30 Terminal equipment
31 Transmitter
32 Receiver
33 Monitoring device
101 Transmission/reception unit
102 Monitoring control unit
103 Storage unit
111 Transmission/reception unit
112 Monitoring control unit
113 Storage unit

What is claimed is:

1. A monitoring device comprising:
a receptor configured to acquire information of level variation in optical power of a control signal transmitted to a transmission path; and
a monitor configured to monitor, when level variation in optical power of the control signal does not satisfy a predetermined condition, the transmission path, based on backscattered light of an optical pulse being output to the transmission path.

2. The monitoring device according to claim 1, further comprising
a storage configured to store measurement data of backscattered light of the optical pulse when level variation in optical power of the control signal satisfies the predetermined condition, wherein
the monitor determines presence/absence of an anomaly in the transmission path, based on a comparison between the measurement data stored in the storage and a measurement result of backscattered light of the optical pulse.

3. The monitoring device according to claim 2, wherein,
when level variation in optical power of the control signal satisfies the predetermined condition, the monitor outputs, for each predetermined time, the optical pulse to the transmission path, acquires measurement data of backscattered light of the output optical pulse, and stores the acquired measurement data in the storage.

4. The monitoring device according to claim 2, further comprising
a transceiver configured to transmit the optical pulse to the transmission path, and measure optical power of backscattered light of the optical pulse, wherein
the monitor stores measurement data of optical power of backscattered light of the optical pulse being measured by the transceiver in the storage.

5. The monitoring device according to claim 1, wherein
the monitor identifies a location of an anomaly in the transmission path, and outputs information of the identified location of the anomaly.

6. The monitoring device according to claim 1, wherein,
when level variation in optical power of a second control signal received from another device via the transmission path does not satisfy the predetermined condition, the monitor transmits, to a transmission source of the second control signal, information indicating that an anomaly occurs in optical power of the second control signal.

7. An optical repeater comprising:
an optical amplifier configured to amplify optical power of signal light being transmitted in a transmission path; and
the monitoring device according to claim 1, wherein
the monitoring device outputs, at an output side of the optical amplifier, the control signal and the optical pulse, and performs measurement of backscattered light of the optical pulse.

8. A monitoring method comprising:
acquiring information of level variation in optical power of a control signal transmitted to a transmission path; and
monitoring, when level variation in optical power of the control signal does not satisfy a predetermined condition, the transmission path, based on backscattered light of an optical pulse being output to the transmission path.

9. The monitoring method according to claim 8, further comprising:
storing, in a storage device, measurement data of backscattered light of the optical pulse when level variation in optical power of the control signal satisfies the predetermined condition; and
determining presence/absence of an anomaly in the transmission path, based on a comparison between the stored measurement data and a measurement result of backscattered light of the optical pulse.

10. The monitoring method according to claim 9, further comprising:
transmitting the optical pulse to the transmission path;
measuring optical power of backscattered light of the optical pulse; and
storing, in the storage device, measurement data of optical power of backscattered light of the optical pulse being measured.
